(19) United States
(12) Patent Application Publication
(10) Pub. No.: US 2025/0116263 A1
(43) Pub. Date: Apr. 10, 2025

(54) EXPANDABLE POWER MODULE FOR BOOSTER PUMPS

(71) Applicants: Carlomagno PATI, Oshawa (CA); Jerard de CASTRO, Scarborough (CA); Alpha PASCUAL, Napanee (CA)

(72) Inventors: Carlomagno PATI, Oshawa (CA); Jerard de CASTRO, Scarborough (CA); Alpha PASCUAL, Napanee (CA)

(21) Appl. No.: 18/831,296

(22) PCT Filed: Apr. 16, 2023
(86) PCT No.: PCT/CA2023/000009

§ 371 Date: Oct. 21, 2024

(51) Int. Cl. F04B 17/03; F04B 49/06; H02H 3/20

(52) U.S. Cl. CPC F04B 17/03; F04B 49/06; H02H 3/20

(57) ABSTRACT

The present disclosure provides a method, system, and a preferred embodiment of the method and system as a booster pump apparatus. The method comprises providing a main module that works with at least four expandable input, output, control, and external energy storage modules. A preferred system implements the method with a control panel, swappable outputs panel, and various remote-control functions. This system has a booster pump design comprising a portable power unit as one embodiment of the main modules. Inputs, switches, and LCD displays are on the control panel. A surge protection module is shared among outputs. An output panel with multiple output ports is located on the side of the main module to distribute power to external devices. A sliding dock is located on the rear side of the main module, where a sliding pump module is inserted, which connects to the main unit and activates the pump function.

### CROSS-REFERENCE TO RELATED APPLICATIONS

This application claims the benefit of U.S. Provisional Patent Application No. 63/332,771, Confirmation No. 6846, filed Apr. 20, 2022. The entire disclosure of the above application is incorporated herein by reference.

### FIELD

The present disclosure is in the field of mechanical and electrical engineering, power unit, battery, booster pumps, and especially, a method and system for a novel portable and expandable power module that can be used with many different kinds of electrical devices such as booster pumps.

### BACKGROUND

A pump is a device that moves a fluid, typically water, from one location to another that requires energy to achieve a goal. Pumps can be used in a variety of applications such as well pumping, filtering, water-cooling, pressure washing, etc. One of many types is a booster pump which increases the pressure of a fluid and improves its flow rate. For example, booster pumps are used in water tanks for multistorey buildings, lawn sprinklers, and pressure washing machines. Many pumps, such as the typical booster pump, are stationary due to their large size and weight; however, there are also very small, light, and portable booster pumps for light-use applications.

However, most pumps only operate on fixed settings, often with one motor speed and water pressure. Hereinafter, in the present disclosure, the term ‘pump’ primarily refers to ‘booster pump’, and the two terms may be used interchangeably. Portable booster pumps with one motor speed and pressure output require a power unit and control logic. Furthermore, each power unit needs an appropriate interface and charging circuitry. As a result, such a device will be limited to a specific purpose (e.g., building water circulation or washing) or a specific device like a booster pump with a specific specification. So, a portable pump device may be used for high-pressure output, but not for dispensing high volumes of water.

Some existing pump devices have the means to adjust pressure output, pump motor speed, and flow rate. Often, this requires making adjustments to the pump's components, such as the wiring, cable, or one of the valves. Hereinafter, the term ‘wiring’ is interchangeable with ‘wire(s)’ or ‘cable(s)’. A person doing these adjustments requires proper equipment and considerable skill. Furthermore, making these adjustments takes a considerable amount of time to do. Therefore, there needs a way to make adjustments to a pump device easily and quickly.

Another related problem is that the output is only the form of liquid flow and pressure, essentially limiting the pump to a specific function. Because the output is limited to just liquid flow and pressure, the pump cannot be used as a different type of electrical device like a drill, fan, etc. Therefore, a device that can do more is required.

Pumps also only configure themselves to one type of energy input, typically a wired connection running on AC or DC power. In the case of portable pumps, they may be powered by a battery, a vehicle's cigarette port, or by a solar power panel. Normally they are configured to only one type of input so hard to switch to an alternative input of energy.

A problem related to the limited input is that the energy storage with traditional pumps is also limited. When storing energy, many portable pump designs use a single battery that is stored internally or externally. However, a pump's battery life is limited unless it is recharged in time. Furthermore, there is often no easy way to change a battery with a larger one. Apart from energy storage, existing pump devices also lack electrical protection for the use of devices. An electrical surge not only disrupts the pump's operation, but it may also damage the devices or the power unit.

The existing means of operational control are also limited, often with only manual control at the device level. In other words, a user would need to press buttons on the pump device's interface to actually control it. Some existing pumps may be remotely controlled with a remote. However, a remote is not very common for such devices and still has many drawbacks. First, the remote can only function from a limited distance. Second, it is limited to one connection type, either wireless or wired; it will be mainly battery operated for a wireless remote. Third, it has limited functionality and flexibility, mainly only turning the pump on or off. Once a remote is built, its functions are not extendable, such as auto automation and programmable controls. Fourth, the remote normally cannot extend its controls to other devices or be used along with other control devices. Fifth, there is also a chance to lose the remote unit, then rendering the device uncontrollable. Overall, limited control options make the existing devices inconvenient to use.

The present disclosure provides a method and system of a novel portable and expandable power module for different devices like booster pumps. The present disclosure addresses the above-mentioned deficiencies and improves upon the following: (1) expanded energy inputs and charging connections; (2) expanded outputs and uses of electrical load devices; (3) expandable control/interfaces and functionalities; (4) expandable energy storage means; (5) expandable protection for outputs electrical load devices; (6) increased flexibility in booster pump usage.

### SUMMARY

The present disclosure provides a method and system of a novel portable and expandable power module that can work with many different kinds of electrical load devices such as booster pumps. The purpose is to create a main module with at least four expandable features—(1) expandable energy inputs, connections, and interfaces; (2) expandable electrical devices or outputs with an optional protection module; (3) expandable additional energy storage and connections; (4) expandable functions and/or controls. The present disclosure has at least the following aspects: (1) a method that achieves expandable inputs, outputs, controls, and additional energy storage units; (2) a system that implements the aforementioned method; (3) a preferred embodiment of the systems as a portable and switchable booster pump apparatus.

In the first aspect of the present disclosure, a method to provide a main module with at least four expandable features is provided, which include, but are not limited to: (1) expandable forms of energy inputs and interfaces; (2) expandable electrical devices or outputs with a shared protection module; (3) an expandable form of extra energy storage besides an optional primary energy unit inside the main module; (4) expandable controls and functions. Essentially, the main module communicates with additional modules and works as a whole system. There are at least four such additional modules with expanded settings: an input module with multiple forms of inputs for powering or charging the main module. Each form of input has at least one interface type that connects the energy input to the main module; an output module includes an electrical load device for realizing a target function, for example, the main pump device for achieving high water pressure, a charging external battery function, and/or an additional other function. A common output protection module in the form of surge protection as such example works alongside the output module to prevent any interference/surprise to the output functions; a control unit module determines how the main module can be controlled and potentially expanded functionalities. The main module can be controlled locally, remotely, manually, or automatically using a communication link or channel. In the case of remote control, various devices may be used to communicate with the main module through various means of connections; an additional energy storage module that expands the main module's energy capacity by connecting with one or more external energy storage devices. The shared protection module also plays a role in expanding and protecting energy storage by maintaining the main module's proper operations and the battery life after any electrical disruption (e.g., voltage spikes, power cutoff).

The second aspect is a system that implements the aforementioned method. This system has a design comprising a portable product body unit as one preferred embodiment of the main modules. Primarily, the main module is now a product unit. There are two panels on the product body: a control panel with multiple inputs and interfaces and displays; an output panel with output ports. Multiple switches are located on the main module for adjusting the input and output settings. A form of output is an interchangeable module, which uses a mechanism to lock in place, connect to the main unit, and carry out an output function. Different interchangeable modules can be swapped to work with the main unit. The product body unit may have a built-in battery or primary internal/external power source for carrying out the main module's function. Wiring within the product body unit connects the primary power source to the other components within the product body unit. The system can be controlled locally on the control panel or remotely via a control unit.

The third aspect is a preferred embodiment of the invention of the present disclosure as a new portable and expandable booster pump apparatus or device. The main product body unit part of the apparatus is also considered the main module in said method. The product's main unit can be opened up by unlocking two latches on the top to reveal the main module's internal components and an internal power source. An internal battery acts as the primary power source for the product body module, with wires connecting the battery terminals with the main module's components. The control panel has a front cover that houses the inputs and display. Three configuration switches are located on the upper left side of the control panel to adjust settings for the input and control modules. Four modes of input—an AC input, a car input, a battery charger input, and a speed controller—are located along the bottom left corner of the control panel. Two displays-one main display and another battery indicator display—are placed on the right side of the control panel to display information to the user. The control panel also has a rear control panel cover that covers the main module's internal components and the components involved with the shared protection module (i.e., surge protection). An output panel is located on the side of the product body with two output ports-a USB port and a cigarette port—for charging other devices; an output power on-off switch activates the two output ports. A sliding dock is located at the rear of the apparatus' product body. An interchangeable sliding pump module, comprising multiple components, is inserted into the hollowed groove of the sliding dock to form a connection with the main module and carry out the pump function. A remote control device is used to remotely control the main module via a communication channel. The main module can also function with an external battery acting as a form of additional energy storage.

By providing the above methods, systems, and preferred design embodiments of the novel portable and expandable power module with at least four expandable features/aspects, the following areas are improved upon by the present disclosure: (1) expanded energy inputs and charging means; (2) expanded output, load, and electrical devices; (3) expanded control/interfaces and functionalities; (4) expanded means of energy storage; (5) expanded protection for the output, load, and electrical devices; (6) increased flexibility in booster pump usage.

### BRIEF DESCRIPTION OF THE DRAWINGS

The accompanying drawings, which are included to provide a further understanding of the invention and are incorporated in and constitute a part of this application, illustrate embodiment(s) of the present disclosure and, together with the description, serve to explain the principle of the invention. For simplicity and clarity, the figures of the present disclosure illustrate a general manner of construction of various embodiments. Descriptions and details of well-known features and techniques may be omitted to avoid unnecessarily obscuring the discussion of the present disclosure's described embodiments. It should be understood that the elements of the figures are not necessarily drawn to scale. Some elements' dimensions may be exaggerated relative to other elements for enhancing the understanding of described embodiments. In the drawings:

FIG. 1 illustrates a method of the present disclosure that has a main module with at least four expandable functions.

FIG. 2 illustrates a preferred general embodiment of the method of the present disclosure.

FIG. 3 illustrates a block diagram outlining the input blocks and controls of the method of the present disclosure and a front view of the control panel cover in the preferred embodiment of the system as a portable and expandable booster pump apparatus.

FIG. 4 illustrates a block diagram outlining the output block of the method of the present 145 disclosure and front and side views of the main module being used for output in the preferred embodiment of the system as a portable and expandable booster pump apparatus.

FIG. 5 illustrates rear, perspective, and exploded views of the connectors, sliding pump module, and the sliding pump module's insertion into the sliding dock of a preferred embodiment device as a portable and expandable booster pump apparatus.

FIG. 6 illustrates the expandable modular control with the main module.

FIG. 7 illustrates front views of an open product body powered by an internal and external expanded battery in the preferred embodiment of the system as a portable and expandable booster pump apparatus.

FIG. 8 illustrates a circuit diagram outlining the surge protection from the main module's shared protection module and perspective views of the control panel's rear control panel cover with surge protection in the preferred embodiment of the system as a portable and expandable booster pump apparatus.

FIG. 9 illustrates an electric circuit schematic outlining the positive wiring relationship within a preferred embodiment device as a portable and expandable booster pump apparatus.

FIG. 10 illustrates an electric circuit schematic outlining the negative wiring relationship within a preferred embodiment device as a portable and expandable booster pump apparatus.

### DETAILED DESCRIPTION

The present disclosure provides a method and system of a novel portable and expandable main module that can work with many different kinds of electrical load devices such as booster pumps. Various examples of the present invention are shown in the figures. However, the present invention is not limited to the illustrated embodiments. In the following description, specific details are mentioned to give a complete understanding of the present disclosure. However, it may likely be evident to a person of ordinary skill in the art; hence, the present disclosure may be applied without mentioning these specific details. The present disclosure is represented as few embodiments; however, the disclosure is not necessarily limited to the particular embodiments illustrated by the figures or description below.

The language employed herein only describes particular embodiments; however, it is not limited to the disclosure's specific embodiments. The terms “they”, “he/she”, or “he or she” are used interchangeably because “they”, “them”, or “their” are considered singular gender-neutral pronouns. The terms “comprise” and/or “comprising” in this specification are intended to specify the presence of stated features, steps, operations, elements, and/or components; however, they do not exclude the presence or addition of other features, steps, operations, elements, components, or groups.

Unless otherwise defined, all terminology used herein, including technical and scientific terms, have the same definition as what is commonly understood by a person of ordinary skill in the art, typically to whom this disclosure belongs. It will be further understood that terms, such as those defined in commonly used dictionaries, should be interpreted as having the same meaning as defined in the context of the relevant art and the present disclosure. Such terms should not be construed in an overly strict sense unless explicitly described herein. It should be understood that multiple techniques and steps are disclosed in the description, each with its own benefit. Each technique or step can also be utilized in conjunction with a single, multiple, or all of the other disclosed techniques or steps. For brevity, the description will avoid repeating each possible combination of the steps unnecessarily. Nonetheless, it should be understood that such combinations are within the scope of the disclosure. Reference will now be made in detail to some embodiments of the present invention, examples of which are illustrated in the accompanying figures.

The first aspect of the present disclosure involves a method that provides a main module with expandable features. Hereinafter, the term ‘expandable features’ is interchangeable with ‘additional modules’. The main module is the core part of the method. One of the implementations of the main module is the core component of the overall product. Such a module may comprise some basic functional components, interfaces, and/or a primary power source. The main module is connected to additional modules for expandable settings; such connections allow for communication between the main module and additional modules to work as a whole system. In a preferred embodiment, at least four expandable features with one or more settings can be added to work with the main module. Hereinafter, the term ‘settings’ is interchangeable with ‘modes’ or just referred to as the feature's name. For example, the term ‘input settings’ is interchangeable with ‘input modes’, ‘modes of input’; or just simply ‘inputs’.

The first expandable module is an input module that provides an additional means of charging or powering the main module. Depending on the embodiment, there may be one, four, or any other number of input settings in this module. In a preferred embodiment, the input module contains four inputs, which include: an AC power input, a car cigarettes input, an external battery input, and solar power panel input. It should be noted that the input module is not limited to such inputs in the general method of the present disclosure. Each form of input has one or more interfaces for allowing the main module to accept the selected form of input. For example, the main module may accept an AC input through an AC power plug with an outlet socket in the North American or European standard. Besides the above four examples of inputs and interfaces, an unlimited number of inputs and their respective interfaces may all be possible.

The second additional module is an output module that allows for an expandable number of outputs and external electrical devices to be connected to the main module. This output module contributes to providing the target functionality of the overall system. The output module may optionally be connected to a common protection module before reaching the main module. One example of such common protection module can be a surge protection circuitry to prevent the disruption of output operation and damage to both the main and output modules. With the shared protection module, the main module has expanded protection for the outputs, load, and electrical devices. Depending on the embodiment, there may be one, three, or any other number of output settings for the output module. In a preferred embodiment, the output module contains three outputs: a main pump device output, a charging function output, and a miscellaneous output for other functions. It should be noted that the output module is not limited to such outputs in this method and/or other embodiments. For example, the miscellaneous output can function as an electrical blower, fan, driller, etc. As a result, the means for output and electrical devices can be extended. Each output may also have multiple functional modes, the number of which may vary depending on the embodiments. For example, the pump device output in the preferred embodiment has two different pump models-a high-pressure pump and a high-volume pump. These two pump models represent the interchangeability of the output module, allowing the pump feature to be adjusted. As a result, there is also increased flexibility in booster pump usage in different situations without the need to have two pump equipment. Such examples of output modules are non-limiting and can apply to all forms of outputs included in the present disclosure.

The third expandable module is a control module for expanding the controls and functions of the main module and overall method. The control module can be used manual or automatical, local or remote method through one or more wired or wireless channels to send control commands and receive module information. For example, the control module uses at least one wireless connection to communicate with the main module. Hereinafter, the term ‘connection’ is interchangeable with ‘link’, ‘communication channel’, or just ‘channel’, This control module may be activated with the use of local manual control (via user directly input) or remotely via a remote control unit in the preferred embodiment. However, other devices, such as a personal computer (PC) or smart mobile device, can be used in other alternative embodiments to remotely control the main module through a cable wired connection to the Internet or a wireless Wi-Fi or cellular connection. This expands the functionality and modules for controlling the main module.

The fourth additional module is an additional energy storage module, which forms an energy connection with the main module to expand both the power capacity and/or battery life. This additional energy storage can be used alongside the main module's own built-in power source or in substitution thereof. In other words, the operational life of the main module may be extended and can further improve functionality for connecting with an external energy storage device. In the preferred embodiment, there is only one additional module added (e.g., an external battery); however, more than one additional energy storage module can be used too (e.g., more than one external battery, solar-powered grid, etc.). Surge protection from the output's shared protection module can also apply to the additional energy storage module to prevent disruption to the main module's operation and the external battery's life.

The second aspect of the present disclosure is a generalized system that implements the method in the first aspect of the present disclosure. The system comprises functional components that realize all the functions of said method. The system has a primary/main unit with or without a built-in power source. The main unit is connected to additional units that provide expandable settings and features; such connections allow for communication between the main unit and additional units to work as a whole system. In a preferred embodiment; at least four expandable features and each feature has one or more settings/models that can work with the main unit.

The main unit has internal components that contribute to the overall function of the main unit and a primary power source used for powering the main unit. The wiring inside the main unit connects the primary power source to the other components within the main unit. The main unit is connected to one or more panels for carrying on the interaction between the main unit and additional units: one or more control panels with one or more input forms/interfaces and displays. A form of input can be connected to the main unit through the corresponding interface on the control panel. Once a form of input is plugged into the control panel, the main unit is powered via the selected source of input. The displays, although not a form of output for expanding output/electrical devices show information to the user, like a pump speed and battery life; an output panel is located on one side of the main unit, which comprises one or more output ports for connecting external devices. Multiple switches on the main unit can be adjusted for using the desired combination of input and output settings. So, one switch may be activated to use one form of input. Another switch can be used to activate the output ports. The system also has a means for connecting an interchangeable module to the main unit via a physical mechanism. The system can be controlled manually, locally, automatically, or remotely via a control unit. The control unit is controlled through one or more wired or wireless channels, media, or mechanisms.

The third aspect of the present disclosure describes a preferred apparatus embodiment as a portable and expandable booster pump device. In a sense, this third aspect follows the first two aspects' principles and designs to build a novel machine. Hereinafter, the ‘booster pump apparatus’ can be interchangeably referred to as a ‘pump device’ or, for brevity, be simply referred to as the ‘main power unit’ in the third aspect of the present disclosure. All the additional modules are shown in approximate locations in relation to the main power unit. In a more specific design, the main unit's rectangular body has two latches on the top that allows the main power unit to open up, revealing the internal components and an internal battery that acts as the main module's primary power source. Positive and negative wiring connect the battery terminals of the internal battery to various components within the main unit so that such components receive power for operational purposes. There is a control panel at the front of the main unit with two covers: a front control panel cover and a rear control panel cover inside the main unit. The front control panel cover serves as the front interface of the apparatus. The control panel cover has slots that are fitted for multiple inputs: an outlet for AC power, a connector outlet for powering the main unit with a car input, a charger port that allows for an outlet to charge the internal battery, and a circular speed controller dial for adjusting the speed of a pump, and, ultimately, its flow rate. Three configuration switches are located on the upper left corner of the control panel cover, which can be adjusted to change the settings for the input and control modules: one switch determines whether the main unit is powered with AC or DC power; another switch determines whether the main unit uses battery power or the car input; a last switch for determining whether the main unit is controlled with manual input on the device or with a remote. Two displays are located on the upper right corner of the control panel to display information to the user: a larger main display shows the speed of the pump and a small battery indicator display shows how much power the internal battery has.

The control panel's other section is a rear control panel cover within the main module's interior that houses the internal components essential to the main unit's operation. A fuse and relay are located on one side of the control panel's rear control panel cover, both of which serve as the surge protection components for the main unit. As a result, there is increased protection for the outputs, load, and external devices.

An output panel is located perpendicular to the control panel. This output panel controls the supplementary output function of the main unit. An on-off switch is located at the top, which activates the output module. Two circular output ports with covers are situated below the on-off switch. Depending on the embodiment, there can be one, three, or any other number of items on this output panel. In the preferred embodiment, there are three items that are lined up in a vertical fashion. A circular on-off switch is located at the top, which activates the charging function of the main unit. Two circular output ports are located directly below the on-off switch: one output port directly below the on-off switch has a USB port for USB devices; another output port directly below the USB output port is a cigarette port for devices that have a car cigarette receptacle.

A sliding dock is present at the rear of the main unit. The sliding dock has a notched hollowed groove and a pump dock connector. An interchangeable sliding pump module is inserted into the notched groove of the sliding dock, connecting to the pump dock connector and allowing for the pump to operate upon the main unit's activation. The sliding pump module comprises many components, including the water pump itself, a motor, a pump connector with wiring, a slide component, a pump motor holder, a slide connector, and a slide wire cover. The slide connector uses a female XT60 connector, which is inserted onto to the dock's male XT60 connector to allow for the pump to operate upon the main unit's activation via the configuration switches. While the connectors are XT60 connectors in the preferred embodiment, it should be noted that it is not limited to such and can be any other connector.

The main unit may be controlled manually, locally, or by a variety of devices that connect to at least one channel or communication link. In the preferred embodiment, the main unit can be controlled by a remote control, which sends a wireless signal to the main module via a channel. Specifically, a remote-control receiver inside the main unit responds to the wireless signal. When not in use, the remote control can be placed inside a remote holder at the rear of the main unit, beside the sliding dock. It should be noted that in other embodiments, any other device like a PC or a smart mobile device may be used to send a signal via a channel to the main module.

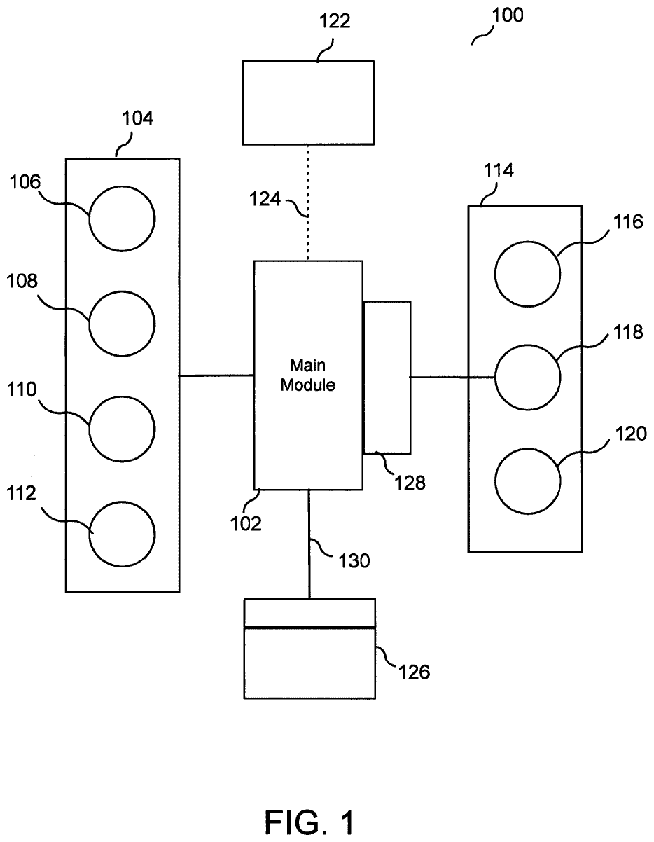

FIG. 1 illustrates a general method of the present disclosure that provides a general device (100) with a main module and at least four expandable features. The main module (102) is in the center and connects with the four feature modules (104, 114, 122, 126) around it, which are the input feature (104), output feature (114), control feature (122), and additional energy storage feature (126). A shared protection module (128) is located between the main module (102) and the output module (114). The input block (104) connects the main module (102) to provide an appropriate form of receiving energy for the general device (100). Without loss of generality, FIG. 1 entails four forms of input (106, 108, 110, 112) for the main module (102) to operate with: a first input (106), a second input (108), a third input (110), and a fourth input (112). For example, the first input (106) is an AC input (106); the second input (108) is a car input; the third input (110) is an external battery input; the fourth input (112) is a solar input. The module (104) makes the general device's (100) input options expandable.

The output block (114) connects the main module (102) to determine an appropriate functional output (116, 118, 120) of the general device (100). Looking at the figure, the output module (114) is connected to the shared module (128) on the right side of the main module (102). As an example, the output block (114) comprises three forms of output (116, 118, 120): a first output (116), a second output (118), a third output (120); also, as an example, the first output (116) can be a pump device; the second output (118) can be a charging output; the third output (120) is an ‘other device/output’. The module (114) makes the general device's (100) output options expandable.

The additional energy storage (126) is connected to the main module (102) through an electrical connection (130). The module (126) is an extra energy storage device that may be the same or different from the primary energy storage inside the main module (102) provided there is one in there. The module (126) makes the general device's (100) energy expandable.

The control unit (122) communicates with the main module (102) for a selected form of control for the general product (100) through a communication link or channel (124). The module (122) makes the general device's (100) control options expandable.

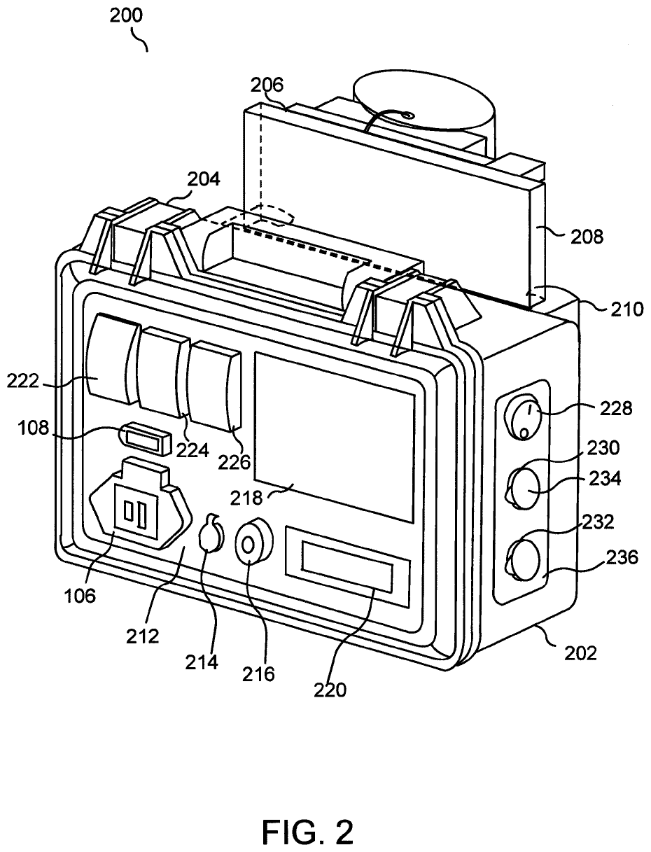

It should be noted that the term ‘main module (102)’ is representative of the architectural component within the method aspect of the present disclosure. The physical product form of the general device (100) is shown in the system and embodiment aspects of the present disclosure; these will be further illustrated and explained in future figures, particularly in FIG. 2.

The placements of the input block (104), output block (114), additional energy storage (126), and control unit (122) are merely for visualization purposes and are not limited to those positions relative to the main module (102). For example, the input block (104) may be placed above the main module (102) in another implementation of the embodiment. What matters is that all the additional modules (104, 114, 122, 126) are placed at the periphery and have a connection to the main module (102) in the middle. It is also key that the output block (114) is directly connected to the shared protection module (128).

In this method embodiment, the input block (104) is shown with four modes of input (106, 108, 110, 112) that expand the ways the main module (102) receives energy. However, the number of inputs (106, 108, 110, 112) does not have to be limited to four; any number of inputs (106, 108, 110, 112) can be incorporated into the input block (104) in other embodiments. For example, the input block (104) may only have one of the inputs present in the main module (102). It should be also noted that the types of inputs (106, 108, 110, 112) are not limited to the AC input (106); car input (108), external battery input (110), and solar power input (112). Other types of inputs in other embodiments may include a USB cable connection to a PC, a parallel port connection to a PC, a form of nuclear energy, hydro power, thermal energy, etc.

Each input (106, 108, 110, 112) within the input block (104) has individual interfaces that allow for the inputs (106, 108, 110, 112) to connect, power, or charge the main module. In a sense, these interfaces are a type of intermediary between each form of input (106, 108, 110, 112) and the main module (102). For example, an AC input (106) connecting the main module (102) may have an adapter head suited for a North American outlet or perhaps an Asian outlet. In another example, the external battery input (110) may connect to the main module via a standard USB cable, a type-C cable, a headphone jack, etc. Each type of input (106, 108, 110, 112) presumably uses one interface to connect to the main module (102), but there may be more than one interface used for each input (106, 108, 110, 112) depending on the embodiment.

In this embodiment, the output block (114) is shown with three modes of output (116, 118, 120) that can be used with the main module (102). However, the number of outputs (116, 118, 120) available is not limited to just three, and any number of outputs (116, 118, 120) can be incorporated into the output block (114) in other embodiments. For example, the output block (114) may only have one of the outputs (116, 118, 120) present in the main module (102). It should be also noted that apart from the pump device (116) and charging output (118), the other output (120) is considered a non-limiting type of output (116, 118, 120) that can further increase the functionality of the product (100). For example, the other output (120) may be a fan, a popcorn machine, a stove, etc.

The shared protection module (128) is connected to the output block (114) to demonstrate how it can add further functionality to the product (100) and the main module (102). In this embodiment, the shared protection module (128) refers to the surge protection to ensure that the product (100) and its main module (102) consistently operate even when presented with voltage spikes as a result of a storm or a disturbance in the electrical line. However, the shared protection module (128) may take on a different function in other embodiments. For example, the shared protection module (128) in another embodiment may allow more than one type of output (116, 118, 120) to operate simultaneously; or the module (128) implements a timer function for one or more output modules.

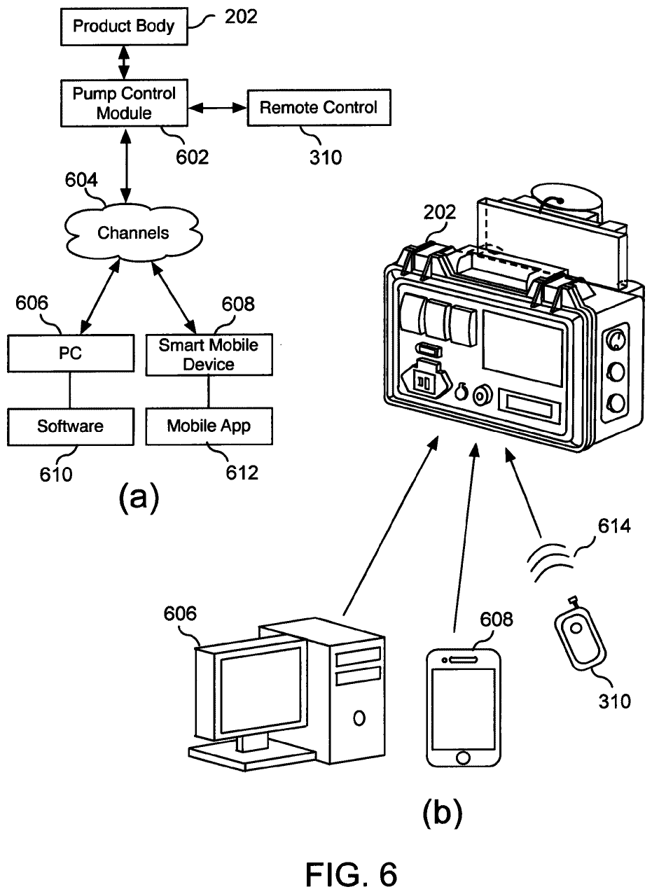

The control unit (122) can be a plurality of devices depending on the embodiment. Such examples may include a remote control, personal computer (PC), smart mobile device, keyboard, control-stick, or any other devices, etc. Each type of control unit in (122) will have its own means of connecting to the main module (102), typically with its own channel (124). Because of the flexibility in the type of control unit (122), it results in an expandable control for the interfaces and functionalities of the main module (102). This will be further shown and explained in future figures, particularly in FIG. 6.

The connection channel (124) in this method embodiment of the present disclosure is a wireless 395 connection between the control unit (122) and the main module (102). However, other embodiments may use a wired connection that directly communicates with the main module (102). For example, a wired remote-control unit or switch can be used to activate/deactivate the main module (102). Likewise, the input block (104), output block (114), and additional energy storage (126) are shown to have physical wired connections for this figure in the preferred embodiment, but they can be connected wirelessly to the main module (102) in alternative embodiments too.

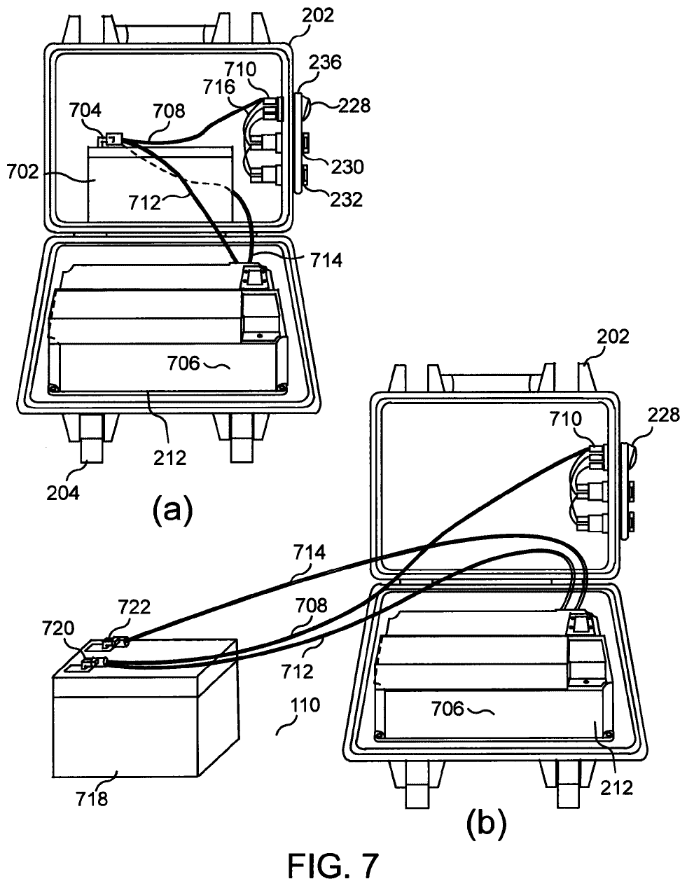

The additional energy storage (126) can comprise a plurality of various energy storage devices. In this embodiment, this additional energy storage (126) takes the form of an external battery, which can be used alongside the primary power source of the main module (102), alongside the energy provided by the inputs (106, 108, 110, 112), or as a substitution thereof. In the preferred embodiment, the primary 405 power source of the main module (102) is an internal rechargeable battery. Other embodiments of the additional energy storage (126) may take the form of a power generator, portable power bank, etc. Overall, having this additional energy storage (126) will help extend the operational life of the main module (102) and extend functionality when more power is needed. The additional energy storage unit (126) will be illustrated with further details in FIG. 7.

FIG. 2 illustrates a preferred embodiment of the system of the present disclosure as a portable and expandable booster pump in the present disclosure. The physical implementation (200) of the general product comprises a main module embodiment (202) that acts as a product body. The product body (202) is a box with latches (204) that locks the product body (202) while protecting the internal components inside the product body (202). A sliding dock (210) is situated at the rear of the product body (202); the top section of the sliding dock (210) is in line with the top rear surface of the product body (202). The sliding dock (210) has a groove with rectangular notches at the peripheral edges of the sliding dock (210). An interchangeable sliding pump module (206) is inserted into the sliding dock (210) notches. The sliding pump module (206) has slider edges (208) at its peripheral sides that line up with the rectangular notches of the sliding dock (210). The sliding mechanism is not the only way to attach and switch an output device. Other mechanisms like clipping, mounting, screwing, containing, tying, or even loosely wired connecting can also be used.

A control panel (212) is located at the front of the product body (202). Facing the front of both the control panel (212) and the product body (202), any number of configuration switches at any switching positions, here, for example, three switches (222, 224, 226) are located on the control panel (212): a first configuration switch (222) is situated at the farthest left side of the three configuration switches (222, 224, 226). The first configuration switch (222) is flipped to an upward position in the figure; a second configuration switch (224) is located in the middle; a third configuration switch (226) is located at the farthest right side of the three configuration switches (222, 224, 226). A large main display (218) is located near the configuration switches on the control panel (212) too. Again, any number of display components can be also used on the control panel (212).

From the front view of the control panel (212), any input and output connections can be also on the control panel (212) or product body (202). In this embodiment, an AC input (106) is located on the bottom left corner of the control panel (212). A car input (108) is located above the AC input (106): A charger port (214) is located on the right side of the AC input (106). A circular speed controller (216) is located on the right side of the charger port (214). A battery information display (220) is located on the right side of the speed controller (216); the battery information display (220) is on the lower right corner of the control panel (212), below the main display (218). Hereinafter, the term ‘battery information display’ is interchangeable with ‘battery indicator display’ and ‘secondary display’. The ‘large main display’ is also called the ‘first display’.

A rectangular output panel (236) is located on the side of the box, perpendicular to the main display (218) and secondary display (220). An output power on-off switch (228) is at the top of the output panel (236). Two output ports are located below the output power on-off switch (228)—a first output port (230) directly below the output power on-off switch (228); a second output port (232) below the first output port (230) and at the bottom of the output panel (236). Both output ports (230, 232) are protected with individual output port covers (234).

The product body (202) takes the form of a rectangular pelican case in the preferred embodiment. However, the product body (202) is not limited to this type and shape. In some alternative embodiments, the product body's (202) shape may be circular, triangular, polyhedron, etc. Modifications to the other components, such as the control panel (212), output panel (236), and the sliding dock (210) may be required to accommodate the new shape of the product body (202). In other embodiments, no latches (204) are present to open up the product body (202) and the internal components are sealed.

It should be noted that the control panel (212) in this figure actually may comprise two covers: a front control panel cover and a rear control panel cover to protect the internal components of the product body (202); this will be further shown in future figures.

The AC input (106), car input (108), and charger input (214) are shown on the system implementation (200) with a particular interface. The AC input (106) is shown to accept a North American style outlet; the car input (108) appears to have an XT60 connector for interfacing with a car's power source via a cable with a cigarette receptacle that fits into a car's cigarette port; the charger input (214) appears to have a circular 3-pin aviator connector for accepting a cylindrical adapter head of a battery charger (e.g., a 12 V SLA charger). However, the interfaces are not limited to what is shown for the noted inputs (106, 108, 214) in the figure and can be modified to fit different interfaces in alternative embodiments. For example, the AC input (106) can be designed to accept an adapter head designed for European or Chinese outlets in one alternative embodiment. In another alternative embodiment, the charger input (214) can have an interface that accepts a standard laptop plug.

The charger input (214) has a male and female 3-pin aviation connector that is rated 5 Amp. However, the charger input (214) can be any type of connector with different current and voltage ratings in alternative embodiments. For example, the charger input (214) can be a standard USB port in one alternative embodiment or a 4-pin XLR connector in another alternative embodiment.

It is noted that this preferred embodiment does not show the solar input or external battery input from the previous figure; however, another embodiment may include such inputs implemented in the physical implementation (200). In one such embodiment, the control panel (212) may have a PV plug for the solar panel input. In another embodiment, the charger socket (214) may be modified to power the product body (202) via an external power bank: In yet another alternative embodiment, a charger port (214) can take the form of an SLA charger port (214) for connecting to an external battery.

The configuration switches (222, 224, 226) in the preferred embodiment are Double Pole Double Throw (DPDT) rocker switches, each of which is rated 12 V 20 Amp. Each configuration switch (222, 224, 226) has three positions for adjusting the product body's (202) settings. More specifically, each configuration switch (222, 224, 226) can be positioned upward or downward to activate a particular input setting, while the middle position of each configuration switch (222, 224, 226) does nothing. It should be noted that the type of switches used for the configuration switches (222, 224, 226) is not limited to that of the preferred embodiment. In one alternative embodiment, the configuration switches (222, 224, 226) can be toggle switches with two or three positions. In another alternative embodiment, the configuration switches (222, 224, 226) can take the form of Single Pole Double Throw Slide switches.

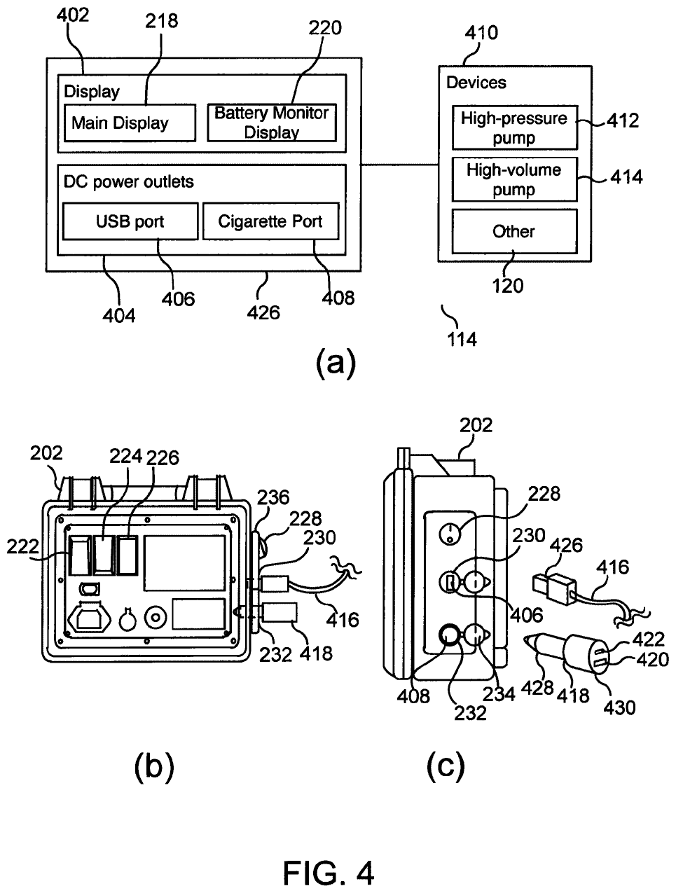

In the preferred embodiment, the configuration switches (222, 224, 226) are designed for adjusting specific input settings: the first configuration switch (222) can be flipped to an upward or downward position to adjust whether the product body (202) is powered with AC or DC power; the second configuration switch (224) can be flipped to an upward or downward position to adjust whether the product body (202) uses an internal battery (i.e., its primary power source) or a car input (108); the third configuration switch (226) can be flipped to an upward or downward position to adjust whether the product body (202) is controlled manually or remotely via a remote control (not shown). The third configuration switch (226) also influences the use of the output ports (230, 232) on the output panel (236); this will be further shown and explained in FIG. 4. It should be noted, however, that the specific settings noted earlier are not limited to their respective configuration switch (222, 224, 226). In other embodiments, the noted settings can be controlled by a different switch. For example, the AC or DC power adjustment in alternative embodiments may be adjusted with the second or third configuration switch (224, 226). It should also be noted that the configuration switches (222, 224, 226) are not limited to just adjusting the settings mentioned in the preferred embodiment. For example, the first configuration switch (222) may instead be used to adjust the information displayed on the main display (218) in an alternative embodiment. In yet another alternative embodiment, the configuration switches (222, 224, 226) can each have a third function when set in the middle.

In the figure, the first configuration switch (222) is flipped to an upward position, while the second and third configuration switches (224, 226) are kept in the middle position. This is mainly for exemplary purposes and it is obvious to those ordinarily skilled in the art that there are numerous combinations in regards to the upward or downward positioning of the configuration switches (222, 224, 226).

Three configuration switches (222, 224, 226) are located on the upper left corner of the control panel (212) at the front side of the product body (202). However, the number of configuration switches (222, 224, 226) and their placement on the control panel (212) are not limited to what is shown in the present disclosure. In some alternative embodiments, there can be four, two, or any number of configuration switches (222, 224, 226) present on the control panel (212). In other embodiments, the configuration switches (222, 224, 226) may be located elsewhere on the control panel (212) or even outside the control panel (212) (e.g., on the side of the product body (202).

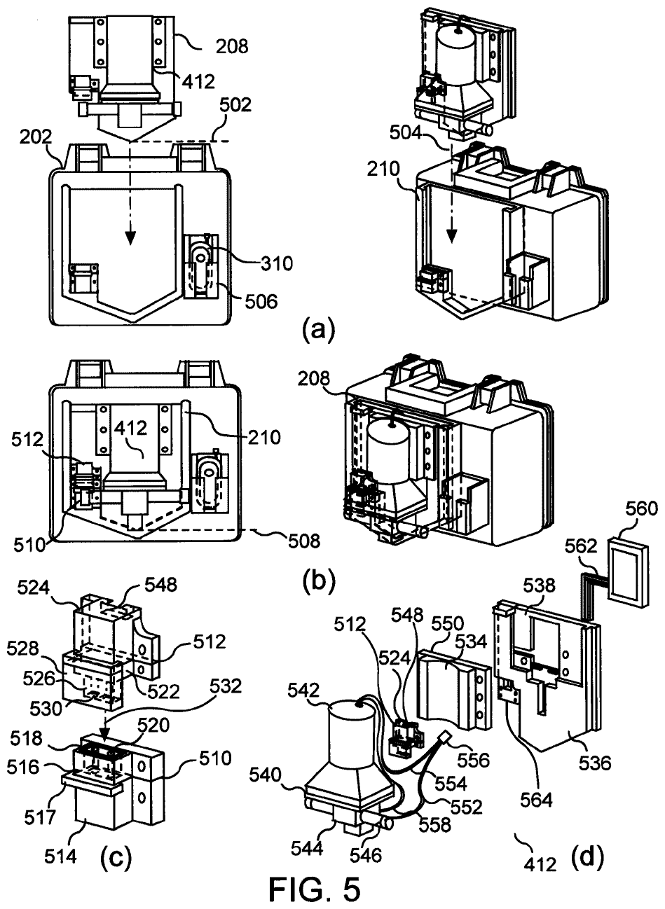

The use of the sliding pump module (206) with the sliding dock (210) allows for easy adjustment of pumps with various parameters such as flow rates to adjust for a particular task (e.g., pressure washing or water distribution). As a result, these components (206, 210), as well as the entire physical implementation (200), contribute to the expanded output and increased flexibility in booster pump usage. The sliding pump module (206) and sliding dock (210) components and the interaction between the two for activating pump usage are further shown and explained in FIG. 5.

The speed controller (216) in the preferred embodiment takes the form of a circular dial with an adjustable momentary start/stop switch and a speed control potentiometer. Ultimately, this allows for the speed controller (216) to be easily operated with stable performance. A user spins the speed controller (216) in one direction or another (clockwise or counterclockwise) in order to increase/decrease pump motor speed, which increases/decreases flow rate. However, the speed controller (216) may take on different forms depending on the embodiment. In one such embodiment, the speed controller (216) can take the form of two push buttons that increase or decrease pump motor speed and flow rate. In another embodiment, a slide switch can be used so that a user pushing the speed controller (216) in one direction increases the pump motor speed and pump flow rate while pressing the speed controller (216) in the other direction decreases the pump motor speed and pump flow rate.

The two displays—the main display (218) and the battery indicator display (220)—are positioned on the right side of the control panel (212). In the preferred embodiment, the main display (218) on the upper right is a much larger rectangular light-emitting diode (LED) screen that shows the speed of the pump. The battery indicator display (220) or secondary display is a smaller rectangular LED screen on the bottom right that shows the battery life of the product body (202). It should be noted that the size, shape, type of screen, and placements of the displays (218, 220) on the control panel (212) are not limited to what is shown in the preferred embodiment. In one exemplary alternative embodiment, the main display (218) can be the same size as the battery indicator display (220) and can be located on the upper left side of the control panel (212). In another exemplary embodiment, the secondary display (220) is integrated into the main display (218). In yet another exemplary embodiment, both the main display (218) and secondary display (220) use a liquid-crystal display (LCD) or plasma display panel screen.

It should also be noted that the displays (218, 220) do not need to be limited to just displaying pump speed (for main display (218)) and battery life (for secondary display (220)) in alternative embodiments. In one exemplary embodiment, the main display (218) can display additional information such as voltage usage, type of input used, etc. In another exemplary embodiment, there can be additional displays mentioning additional information like water volume, flow, time of day, etc.

The output panel (236) is shown as a rectangular panel on the right perpendicular side of the control panel (212). In an alternative embodiment, the output panel (236) can be a circular shape rather than a rectangular shape. In another alternative embodiment, the output panel (236) and associated components (228, 230, 232) can be located on the control panel (212).

The output power on-off switch (228) in the preferred embodiment is considered a two-position switch, having an ‘on’ and an ‘off’ position. In this figure, it is flipped to a downward position to indicate an ‘off’ position, but can be flipped to an upward position to activate the output ports (230, 232). In an alternative embodiment, the output power on-off switch (228) can be a different type of switch, such as a push-button switch, a joystick switch, etc. More importantly, to activate the output ports (230, 232), the third configuration switch (226) needs to be off; this will be further shown and explained in FIG. 4.

There are two output ports (230, 232) below the output power on-off switch (228). These output ports (230, 232) are designated for charging output; this will be further shown and explained in FIG. 4. It should be noted that the number of output ports (230, 232) is not limited to the number and position shown in the preferred embodiment (i.e.; two output ports (230, 232) below the output power on-off switch (228)). There can be any number of output ports (230, 232) in other alternative embodiments. In one exemplary embodiment, there can be four output ports (230, 232) with two output ports (230, 232) horizontally aligned together below the output power on-off switch (228) and another two below those output ports (230, 232). In another alternative embodiment, the output ports (230, 232) can be located above the output power on-off switch (228).

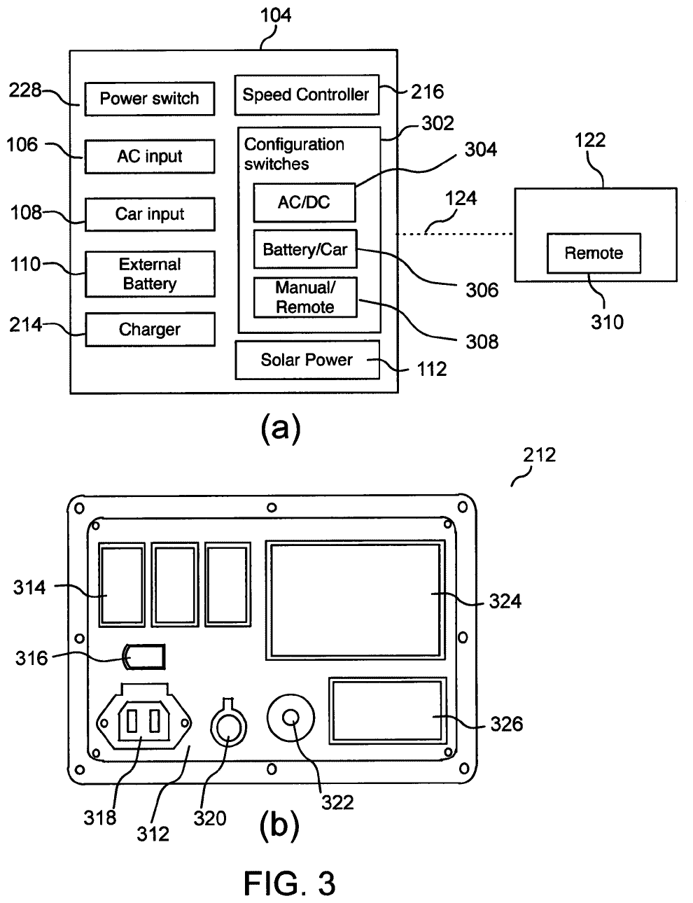

FIG. 3 illustrates a block diagram outlining the input blocks and controls of the method of the present disclosure and a front view of the control panel cover in the preferred embodiment of the system as a portable and expandable booster pump device. Sub-figure (a) illustrates a block diagram outlining the input (104) and controls (122) of the methods of the present disclosure. An input block (104) comprises multiple energy inputs that provided energy to the main module. All′ descriptions of the input block (104) and various inputs from previous figures also apply here. An AC input (106) accepts an AC power plug for the main module to run on AC power. A car input (108) allows the apparatus to be powered from a car's battery via the car cigarette port. An external battery (110) can be used to power the main module with an external power bank. A charger port (214) allows for the main module's primary power source, the internal battery, to be charged; it is also a form of DC power for the main module. The input block (104) also includes an option for solar power input (112), which can link the main module to a solar panel device for charging or general operation.

The input block (104) also comprises input made by a user or what the user needs to press to generate the main module's output. An output power switch (228), although considered part of the output, requires a user to press in order to activate the output ports. A speed controller (216) lets the user adjust the flow rate by adjusting the motor speed of the pump. Three configuration switches (302) can configure specific input settings for the main module, which comprise the following: an AC/DC switch (304) for powering the main module via AC or DC power; a battery/car switch (306) to adjust whether the main module is powered by the internal battery or car input (108); a manual/remote switch (308) for determining whether the main module is adjusted manually or remotely with an external device. A control unit (122) can communicate with the input block and the main module via a communication channel (124). The control unit (122) is a general device that a user can use to activate a main module. In this embodiment, a 585 remote control (310) is considered one of such control units (122). Provided that the remote option is chosen for the manual/remote switch (308), the remote (310) can be used to activate the main module.

In the preferred embodiment, the input (104) operates at a voltage range of DC6V-60V. For example, the speed controller (216) can operate at 12 V, 24 V, 36 V, and 48V. However, other input (104) voltages outside this range can be used in other embodiments, being lower than 6V or higher than 60V if needed. The voltage range for input (104) can also be broader or narrower depending on the embodiment. Typically, the input (104) voltage used should be the same as the motor from the sliding pump module.

Sub-figure (b) illustrates a front view of the front control panel cover piece (312) in the preferred embodiment of the system as a portable and expandable booster pump. The front control panel cover (312) is a rectangular cover piece that installs the front interface with the main module. It has hollow slots (314, 316, 318, 320, 322, 324, 326) to mount the other control panel components, namely the input components and the displays. Three slots (314) for the configuration switches are located on the upper left of the front control panel cover (312). A car input slot (316) below one of the configuration switch-slots (314) allows for the female XT60 connector to be installed for receiving a car cigarette lighter socket plug. An AC slot (318) is located below the car input slot (316); a cover for the AC input would be inserted in front of the AC slot (318) on the front control panel cover (312), while the AC outlet itself and associated wiring are fitted into it from behind the front control panel cover (312). A charger slot (320) is situated beside the AC slot (318) for the charger input; a cover for the charger input would be inserted in front of the charger slot (320) on the front control panel cover (312), while the charger outlet is fitted into the charger slot (320) from behind the front control panel cover (312). A speed controller slot (322) is situated beside the charger slot (320) for the speed controller dial; a small hole in the middle allows the actual speed controller knob to fit into the speed controller slot (322) from behind the front control panel cover (312), while a circular knob is placed in front of the speed controller slot (322) on the front control panel cover (312) to cover and facilitate the turning of the actual speed controller knob. Two display slots (324, 326) are located on the right side of the front control panel cover (312) to house the display screens: one larger main display slot (324) at the upper right corner and one smaller battery indicator display slot (326) at the lower right corner.

FIG. 4 illustrates a block diagram outlining the output block of the method of the present disclosure and front and side views of the main module being used for output in the preferred embodiment of the system as a portable and expandable booster pump apparatus. Sub-figure (a) illustrates the output block (114) of the method of the present disclosure. The output block (114) comprises two types of outputs. The first type of output is internal outputs (426) that are embedded in the main module itself, which includes the following: a display output (402) comprising the main display (218) and a battery monitor display (220) that shows information to the user; DC power outlets (404) comprising a USB port (406) and a cigarette port (408). The second type of output for the output block (114) is a device output (410), which is separate from the main module. The device output (410) comprises a variety of devices such as a high-pressure pump (412), high-volume pump (414), or miscellaneous ‘other devices (120)’. The device output (410) is connected to the internal output block (426).

The DC power outlets (404) in the preferred embodiment primarily use a USB port (406) and cigarette port (408). Typically, these would be used for charging devices like smart mobile devices. The USB port (406) and cigarette port (408) embody the first and second output ports on the output panel (236) of the main module; this will be shown in the next two sub-figures. Essentially, these DC power outlets (404) serve as a physical embodiment of the charging output from the method aspect shown in FIG. 1. However, these ports (406, 408) are two non-limiting examples of DC power outlets (404) available for the main module. In one exemplary embodiment, the DC power outlet (404) may include a parallel port for connecting to a computer. In another exemplary embodiment, a Mini-VGA or HDMI port may be used to connect the main module to a monitor.

The device output (410) allows for increased flexibility in booster pump usage via the high-pressure pump (412) and high-volume pump (414) as an exemplary embodiment of the method aspect shown in FIG. 1. It should be noted that these are not to limit the outputs to just these examples. In another embodiment, a submersible pump can be used as a form of device output (410) for the main module. In yet 635 another exemplary embodiment, a trash pump may be used.

The miscellaneous ‘other device (120)’ allows for the main module to have an expanded output and functionality with expanded electrical devices. Depending on the embodiment, the miscellaneous ‘other device (120)’ may include an expansive variety of devices like a fan, a heater, a camera, etc.

Sub-figure (b) illustrates a front view of the product body (202) being used for output. The three configuration switches (222, 224, 226) are positioned as shown: the first configuration switch (222) is flipped to a downward position to power the product body (202) with DC power; the second configuration switch (224) is flipped to an upward position to activate the battery inside the product body (202); the third configuration switch (226) is left alone in the middle position, keeping the pump function off. Moving to the output panel (236) on the product body's (202) right side, the output power on-off switch (228) is flipped upward to activate the product body's (202) output. A USB cable (416) is inserted into the first output slot (230). A cigarette lighter receptacle (418) is inserted in the second output slot (232).

The first and second configurations switches (222, 224) are not limited to the flipped positions shown in the sub-figure and each can be flipped to an upward or downward position in other embodiments. Only the position of the third configuration switch (226) is key in activating the charging output of the product body (202), whereas the middle position of the third configuration switch (226) keeps the pump output off. The output power on-off switch (228) can be flipped to an upward position to activate the output ports below (230, 232). Once that occurs, configuring the third configuration switch (226) will do nothing regardless of position. The same applies to the output power on-off switch (228), where it becomes inactive and does nothing if the third configuration switch (226) is activated first. In that case, the pump output would be active and the charging output would not be active. In a sense, this acts as a sort of failsafe to prevent any excess voltage use that may cause a disturbance in the product body's (202) operation. If both the third configuration switch (226) and the output power on-off switch (228) are flipped to their respective active positions, the first one activated would be the active one. To switch between the outputs, the one that activated first must be turned off prior to turning on the other.

In an alternative embodiment, however, there may be a way to have the pump output and the charging output work simultaneously without one cutting off the other. However, modifications to both the interior wiring and surge protection may be needed in order for such an embodiment to function properly.

Sub-figure (c) illustrates a side view of the product body (202) being used for output. With the output power on-off switch (228) turned on, the output port covers (234) open horizontally to the right to reveal a USB port (406) inside the first output port (230) and a cigarette port (408) inside the second output port (232). The USB socket (426) of the USB cable (416) is inserted into the USB port (406) of the first output port (230). The receptacle socket connector (428) of the cigarette lighter receptacle (418) is inserted into the cigarette port (408) of the second output port (232). The receptacle adapter head (430) of the cigarette lighter receptacle (418) has two receptacle ports (420, 422) for connecting an external device: a receptacle USB port (420) at the bottom and a receptacle Type-C port (422) at the top.

The types and placements of DC power outlets within the output ports (230, 232) are not limited to what is shown in the preferred embodiment in sub-figures (b) and (c). In an alternative embodiment, the USB port (406) can be in the second output port (232) and the cigarette port (408) can be in the first output port (230). In another exemplary embodiment, both output ports (230, 232) can have only USB ports (406) or cigarette ports (408).

The cigarette lighter receptacle (418), particularly its receptacle adapter head (430) is not limited to the design shown in sub-figures (b) and (c). In one exemplary alternative embodiment, the receptacle adapter head (430) may be squarish in shape and include a voltmeter, a digital clock, etc. In other alternative embodiments, the receptacle adapter head (430) can have any number of receptacle USB ports (420) and/or receptacle Type-C ports (422).

The USB port (406) and cigarette port (408) is designed to give out an output at various voltages, typically at 9V-12V/1.5 A by default. The maximum power output generated depends on the power of the internal battery (not shown). So, if the power generated is 12V, the maximum power output is 120 W. If the power generated is 24V, the maximum power output is 250 W. However, such power and voltage outputs for these ports are non-limiting examples and can vary in other alternative embodiments. In one such embodiment, the USB port (406) and cigarette port (408) both generate a voltage output of 3.6-6.5 V/3 A each. In another embodiment, the USB port (406) and cigarette port (408) both generate a voltage output of 6.5V/9V/12 A each.

The output ports (230, 232) appear to be circular in shape. However, they are not limited to just being circular and can be squarish, triangular, diamond-shaped, or any other shape in other alternative embodiments. However, the output ports (230, 232) still need to be able to accommodate the shapes of the USB port (406) and the cigarette port (408).

FIG. 5 illustrates rear, perspective, and exploded views of the connectors, sliding pump module, and the sliding pump module's insertion into the sliding dock of a preferred embodiment device as a portable and expandable booster pump apparatus. In particular, the sliding pump module shown in this figure is a high-pressure pump (412). Sub-figure (a) illustrates front and perspective views of the high-pressure pump (412) module away from the sliding dock (210) of the product body (202). The high-pressure pump (412) is situated at an initial position (502) above the sliding dock (210) of the product body (202). This initial position (502) is marked along the bottom edge of the pump module (412). The slider edges (208) of the pump module (412) are in line with the notches on the peripheral sides of the sliding dock (210). The high-pressure pump (412) moves in a downward direction (504) to insert into the notched groove of the sliding dock (210). Looking at the rear side of the product body (202), a remote holder (506) is located on the right side of the sliding dock (210). A remote control (310) is inserted in the hollow space within the remote holder (506).

Sub-figure (b) illustrates front and perspective views of the high-pressure pump module (412) completely inserted into the sliding dock (210) of the product body (202). The pump module (412) slides into a final position (508) within the sliding dock (210), marked at the bottom edge of the pump module (412). The slider edges (208) are in line with the rectangular notches of the sliding dock (210). The top side of the pump module (412) is in line with the top side of the sliding dock (210). At the same time, the slide connector (512) is connected to the pump dock connector (510) below.

The remote control (310) and remote holder (506) are only shown for aesthetic purposes and do not play a role in the pump module's (412) insertion into the sliding dock (210). The remote control (310) will be shown further in FIG. 6.

The slide connector (512) and pump dock connector (510) provide the means of transmitting electrical power from the product body's (202) internal battery to the pump module (412) for its operation. Male and female connectors are used with the dock and slide connectors (510, 512) respectively, for this transmission of electrical power; the components of the dock and slide connectors (510, 512) are shown in the next sub-figure.

The pump module's (412) insertion and removal from the product body (202) are key in providing a means for expanded output and increased flexibility in booster pump usage. The high-pressure pump (412) used in the preferred embodiment is more ideal for applications like a sprinkler system or for pressure washing. It should be noted, however, that this type of pump module (412) is a non-limiting example, and another type of pump module can be used in place of the high-pressure pump (412) in other 725 embodiments. In one exemplary embodiment, a high-volume pump can be used to increase the amount of water flow meant for applications like irrigation. Essentially, one product body (202) can easily be used for different applications with the correct type of pump module (412) inserted.

Sub-figure (c) illustrates a perspective view of the slide and dock connectors (510, 512) that connect the pump module to the sliding dock. Looking at the sub-figure, the front sides of the pump dock connector (510) and the slide connector (512) are facing the left side. The pump dock connector (510) is situated below the slide connector (512). The pump dock connector (510) has two sectional components comprising a first dock connector component (514) at the bottom and a second dock connector component (516) at the top. The first dock connector component (514) has a rectangular ridge (517) that covers the top section of the first dock connector component's (514) front and peripheral sides. The second dock connector component (516) has a hollow rectangular slot, shown on the top side of the second dock connector component (516). A hollow male XT60 connector (518) is situated inside this rectangular slot; two cylindrical pins (520) are situated within the interior space of the male XT60 connector (518).

The slide connector (512) is above the pump dock connector (510). The slide connector (512) has two sections with a first slider connector component (522) at the bottom and a second slider connector component (524) at the top. A female XT60 connector (526) protrudes from the bottom of the first slider connector component (522); the female XT60 connector (526) has two circular slots (530). A rectangular component cover (528) shields the first slider connector component (522) and the female XT60 connector (526). A pump connector port (548) is located behind the top section of the second slider connector component (524), which accepts a pump connector for transmitting electrical power from the main module to the pump module.

The slide connector (512) moves in a downward direction (532) toward the pump dock connector (510). There, the female XT60 connector (526) is inserted into the male XT60 connector (518); the pins (520) of the male XT60 connector (518) are inserted into the slots (530) of the female XT60 connector (526). At the same time, the bottom of the slide connector's component cover (528) touches the top of the rectangular ridge (517) along the first dock connector component (514). In doing so, the component cover (528) covers the front side of the second dock connector component (516).

The slide and dock connectors (510, 512) in the preferred embodiment use XT60 connectors (518, 526) as a way to transmit electrical power from the main module to the pump module (412). The XT60 connectors (518, 526) can handle up to 30 Amps of power. However, the slide and dock connectors (510, 512) are not limited to just using XT60 connectors (518, 526). A variety of other power connectors with different power settings may be used in other embodiments such as an XT30 connector, a Deans plug, EC3 connector, HXT connector, etc.

Sub-figure (d) illustrates an exploded perspective view of the components of the high-pressure pump module (412). Looking at the sub-figure, the front of the pump module (412) is shown facing the lower left side, while the rear of the pump module (412) is shown facing the upper right side. From the front, a water pump (540) is shown below a cylindrical motor (542). The water pump (540) comprises a pump head (544) with lower and upper sections. Two water pipes (546) protrude from the pump head's (544) upper section on the left and right sides. Two positive pump wires (552, 558) are connected at the rear of the pump head (544): a first positive pump wire (552) starts from the pump head's (544) lower section and protrudes outward from the pump head (544); a second positive pump wire (558) starts from the pump head's (544) upper section and connects to the top of the motor (542). A negative pump wire (554) protrudes from the top of the pump motor (542) to join together with the first positive pump wire (552) to form a pump connector with a pump connector head (556). The pump connector head (556) connects to the pump connector port (548) behind the slide connector (512), where the first positive pump wire (552) and the negative pump wire (554) transmit electrical power to the pump motor (542) and, naturally, the rest of the pump module (412).

The pump motor (542) is held in place by the pump motor holder (534, 550), particularly the pump motor holder groove (534). A squarish pump motor holder base (550) behind the pump motor holder groove (534) is fixed onto a slide backplane (536), particularly in front of the first backplane groove (538). The slide connector (512) is shown between the water pump (540) and the pump motor holder (534, 550). The connector (512) is attached to a second backplane groove (564) in front of the lower left side of the slide backplane (536).

A slide wire cover (560, 562) comprising a rectangular first slide wire cover component (560) and an inverted L-shaped second slide wire cover component (562) is situated at the rear of the slide backplane (536). The large rectangular slot on the slide backplane (536) is covered by the first slide wire cover component (560), while the top part of the second slide wire cover component (562) covers the smaller slot next to the aforementioned rectangular slot on the slide backplane (536). The vertical portion of the second slide wire cover component (562) is directly above the second backplane groove (564). The first positive pump wire (552), the negative pump wire (554), and the pump connector head (556) are situated behind the pump motor holder base (550) and onto the grooves of the slide wire cover components (560, 562), eventually connecting the connector port (548) at the rear of the slide connector (512), particularly at the second slider connector component (524).

All the pump module's (412) components listed above are fastened to one another using screws in the preferred embodiment. To some extent, this allows for different water pumps (540) and motors (542) to attach to the other components of the slide module. As a result, this expands both the output and the flexibility in booster pump usage. So, in an alternative embodiment, it may be possible to switch the water pump (540) and motor (542) used for a high-pressure pump (412) with those that are used for high-volume purposes. It should be noted that some of the other pump module's (412) components, like the slide connector (512) or pump motor holder (534, 550), may need to be modified to accommodate such changes.

The use of screws to connect pump module (412) components is a non-limiting example of how the components come together as one pump module (412). The components of the pump module (412) can be fastened to one another by different means in other embodiments. Such examples include a snapping lock mechanism, a permanent adhesive, Velcro straps, etc.

FIG. 6 illustrates the expandable modular control of the main module. Sub-figure (a) illustrates a block diagram of the expandable control of the product body (202). The product body (202) has a pump control module (602) that can communicate with external control units. The pump control module (602) can directly communicate with a remote control (310) to activate the product body's (202) function. The pump control module (602) can also communicate with a personal computer, aka, PC, (606) or smart mobile device (608) with the use of at least one communication channel (604). More specifically, the software (610) from a PC or a mobile app (612) from a smart mobile device (608) can command the pump control module (602) and control pump functions for the product body (202) via at least one remote channel (604).

The communication channels (604) are key in realizing expanded control for the product body (202). One communication channel (604) can act as a sort of intermediary between the product body (202) and any device. The types of communication channels (604) are a non-limiting means of controlling the flow of data (i.e., signal to control unit) and may comprise various types (604) like an internet connection (e.g., Wi-Fi), digital connection (e.g., Bluetooth), a radio connection (e.g., radiofrequency (RF) waves), etc. As a result, an expanded number of devices can be used to control the product body (202), which ultimately expands control and, to an extent, functionality.

The communication (604) in the preferred embodiment is wireless. But it may also comprise a variety of means for devices like the PC (606) and smart mobile device (608) to communicate with the pump control module (602) and product body (202). A communication channel (604) may be a Wi-Fi network, a LAN network, a telecommunication network (e.g., mobile data), Bluetooth, or any other wireless network depending on the embodiment. Other examples of wireless communication channels (604) that can be used by non-computerized devices include radio waves, microwaves, etc.

820 Depending on the embodiment, the PC (606) and smart mobile device (608) may communicate with the main control module (602) through one common communication channel (604) or with their own individual channels (604). The PC (606) uses software (610) and the smart mobile device (608) uses a mobile app (612), both of which act as the interface for the user to interact with the product body (202) when using the respective devices (606, 608). The software (610) and mobile app (612) are embedded with dedicated software codes that can form a connection with a component (e.g., a transmitter) inside the pump control 825 module (602) and product body (202). Once, the connection is made, the software (610) and/or mobile app (612) can control the product body (202) via the channels (604).

In an alternative embodiment, the communication channel (604) can be a wired form, which attaches directly to the product body (202) for control. For example, the remote control (310) can be wired to directly connect to the internal components of the pump control module (602) and the product body (202). This type of wired connection is less prone to interference; however, the distance for controlling the product body (202) is limited by the fixed length of such a wire. Examples of wired channels may include coaxial cable, telephone landline, fiber-optic cable, etc.

Sub-figure (b) illustrates the means of expandable modular control for the product body (202). All descriptions of the PC (606), smart mobile device (608), and remote control (310) from the previous sub-figure also apply here. The remote control (310) uses radiofrequency waves (614) to communicate with and command the product body (202). The PC (606), smart mobile device (608), and remote control (310) are exemplary representations of the devices that can be used for modular control of the product body (202). However, modular control is not limited to only these devices. In other embodiments, additional devices may be used to further expand the control of the product body (202). Such devices may include a smart 840 wearable device, a digital assistant, an MP3 player, a graphics tablet, a pager, a camera (via menu control), a fax machine, etc.

FIG. 7 illustrates front views of an open product body powered by an internal and external expanded rechargeable battery in the preferred embodiment of the system as a portable and expandable booster pump apparatus. Sub-figure (a) illustrates such a view for an internal battery (702). The latches (204) on the top of the product body (202) are unlocked. The front of the product body (202) opens up by tilting the front section downward along the product body's (202) bottom side. An internal battery (702) is situated at the center of the product body's (202) interior, particularly in the rear section that is standing upright. The battery (702) has multiple internal battery terminals (704) that act as electrical contacts for connecting battery cables (708, 712, 714) to the product body's (202) components. Looking at the sub-figure, the internal battery terminals (704) are on the top left side of the internal battery (702). A first battery cable (708) connects an internal battery terminal (704) to an output wire connector (710) next to the output power on-off switch (228). More specifically, the output power on-off switch (228) is connected to three output wire connectors (710) that are vertically in line with one another; the top output wire connector (710) is the one connected to this first battery cable (708). A second battery cable (712) connects an internal battery terminal (704) to the rear control panel cover (706) of the control panel (212), presumably connecting to an interior component of the product body (202). A third battery cable (714), located behind the internal battery (702), connects another internal battery terminal (704) to the rear control panel cover (706) of the control panel (212), Looking at the figure, both the second and third battery cables (712, 714) are connected to the rear control panel cover (706) from its rear side when the product body's (202) front section is facing downward. The output power on-off switch (228), the first output port (230), and the second output port (232) on the output panel (236) have multiple output wire connectors (710) with multiple output cables (716) linking one output panel (236) component (228, 230, 232) to another.

Those ordinarily skilled in the art would find it obvious that standard rechargeable batteries (702) are typically equipped with two battery terminals (704): one positive terminal and one negative terminal. While the other internal battery terminal (704) is not shown on the internal battery (702) due to the sub-figure's view, it will be more clearly shown in the next sub-figure. It should be noted, however, that some batteries (702) in alternative embodiments may have more than two battery terminals (704), having three, four, or any number of terminals (704).

Sub-figure (b) illustrates a front view of an open product body (202) powered by both an internal and external expanded rechargeable battery (718) in an alternative embodiment of the present disclosure. The sub-figure is a physical implementation of the external battery input (110) from the method aspect of the present disclosure. All descriptions of the battery cables (708, 712, 714), output wire connectors (710), output cables (716), and rear control panel cover (706) from the previous sub-figure also apply here. The front section of the product body (202) is facing downward when open, much like in the previous sub-figure. An external rechargeable battery (718) is situated outside the product body (202). Looking at the sub-figure, the external rechargeable battery (718) is on the left side of the product body (202). The top side of the external rechargeable battery (718) has two external battery terminals (720, 722): a first external battery terminal (720) on the front left side and a second external battery terminal (722) on the rear left side. From the front view, the external battery terminals (720, 722) are situated along the external battery's (718) left short edge.

A first battery cable (708) connects the first external battery terminal (720) to the top wire connector (710) next to the output power on-off switch (228). A second battery cable (712) connects the first external battery terminal (720) to the rear side of the control panel's (212) rear control panel cover (706). A third battery cable (714) connects the second external battery terminal (722) to the rear side of the control panel's (212) rear control panel cover (706).

The sub-figure exemplifies how additional energy storage can be achieved. More importantly, it is a physical implementation of the external battery input (110) from the method of the present disclosure. It is also exemplary of the system aspect of the present disclosure. The product body (202) can still operate while it is open, provided that all the required cables are properly connected to the external battery (718). In another alternative embodiment, the product body (202) can work with both an internal battery (702) and an external battery (718).

The internal rechargeable battery (702) shown in sub-figure (a) is a Sealed Lead-Acid (SLA) battery in the preferred embodiment of the present disclosure. It is reasonable to assume that the external battery (718) from sub-figure (b) is also an SLA battery. It should be noted, however, that a different type of battery (702, 718) can be used in other alternative embodiments. Such examples in other embodiments may include Lead-Acid, Nickel-Cadmium (NiCd), Nickel-Metal Hydride (NiMH), Lithium-Ion (Li-ion), lithium-ion polymer (LiPo) batteries, etc. However, such batteries (702, 718) still require battery terminals (704, 720, 722), so that the battery cables (708, 712, 714) connect the battery terminals (704, 720, 722) to the components of the product body (202), the control panel (212), and the output panel (236). Weather-resistant casing for protection against moisture and other elements is also important if an external battery (718) is used with the product body (202).

In yet another alternative embodiment, the external battery (718) may be a standard portable power bank that can be plugged in through the control panel (212). Modifications to the battery cable (708, 712, 714) connections may need to be delegated to the appropriate internal components within the control panel (212) in order to accommodate a connection to this portable power bank.

In sub-figure (b), the first external battery terminal (720) is a negative battery terminal and the second external battery terminal (722) is a positive terminal. However, it should be noted that the external battery terminals (720, 722) are not limited to those charges and can be switched in another embodiment so that the first external battery terminal (720) is a positive battery terminal and the second external battery terminal (722) is a negative battery terminal. The placement of the external battery terminals (720, 722) may also be different in other embodiments, but they are typically side by side. So, for example, an external battery (718) may have external battery terminals (720, 722) on the front left and right sides, along with one of the long edges of the t external battery (718). Such embodiments may also apply to the battery terminals (704) of the internal battery (702) as well.

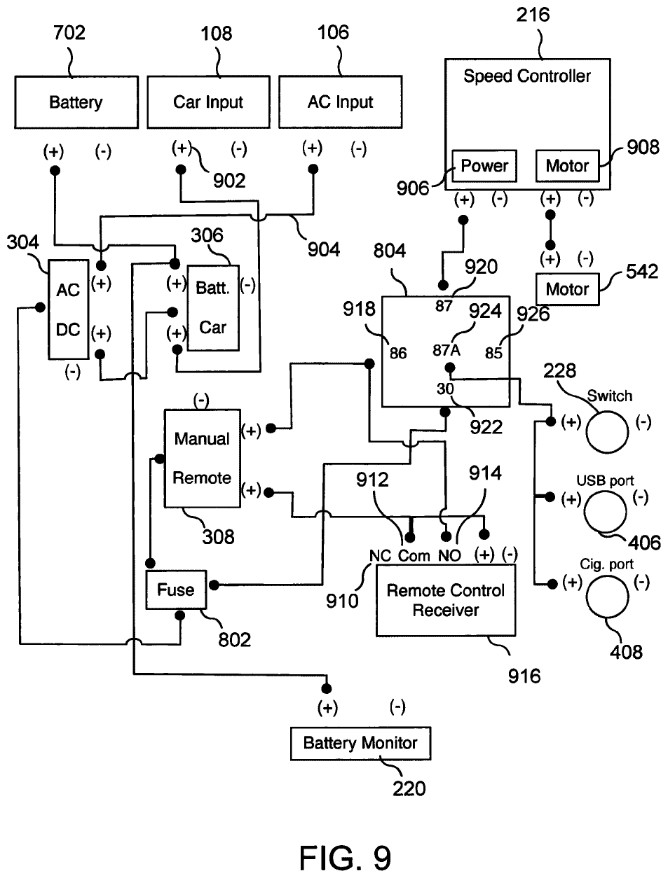

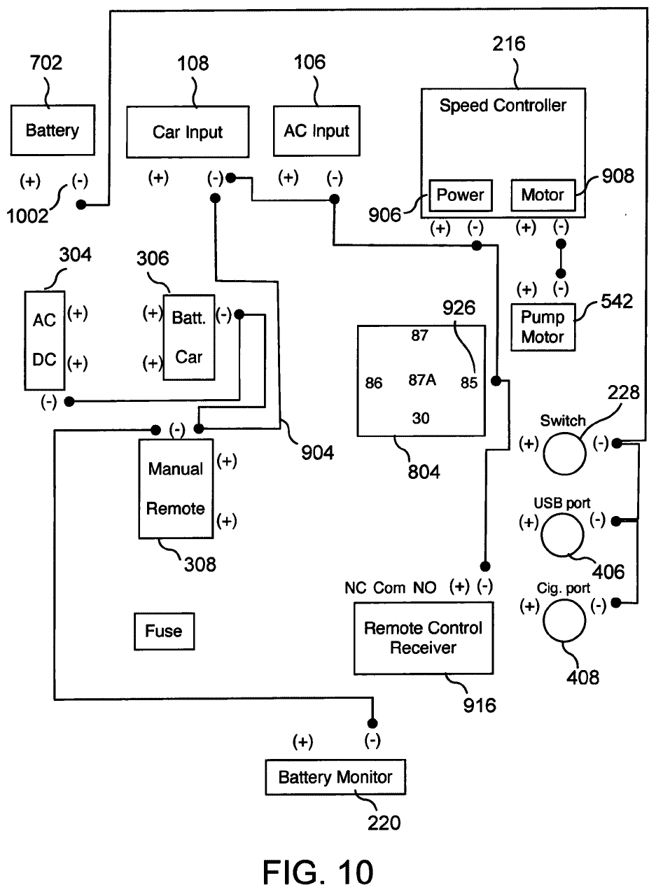

All battery cables (708, 712, 714) in the figure are represented as negative or positive cables, typically depending on which terminal (704, 720, 722) they are attached to. The output cables (716) have their own positive and negative wiring between the components of the output panel (236). The negative and positive wiring for the product body (202) is further shown in FIGS. 9 and 10.

It should be noted that the general number of battery cables (708, 712, 714) in the product body (202) and the number of battery cables (708, 712, 714) connected to each terminal (704, 720, 722) is non-limiting and be any number depending on the embodiment. In one exemplary alternative embodiment, the second external battery terminal (722) may have at least seven battery cables (708, 712, 714) rather than just one, while the first external battery terminal (720) may have three battery cables (708, 712, 714).

The connections between the output wire connectors (710) via the output cables (716) are primarily shown for exemplary purposes and are not limited to the shown particular connections shown in other alternative embodiments. Essentially, the output cables (716) can connect to any of the output wire connectors (710) in an expansive number of ways. It should be noted that the first battery cable (708) needs to be connected to one of the output wire connectors (710) next to the output power on-off switch (228); this will be further shown in FIGS. 9 and 10. The purpose of this is to ensure that the output power on-off switch (228) gets power from the battery (702, 718), which can then supply power to the two output ports (230, 232) via the output cables (716). Any of the output wire connectors (710) next to the output on-off power switch (228) may be connected to the first battery cable (708) depending on the embodiment.

The output power on-off switch (228) is flipped to a downward position in both sub-figures to show that the charging output function is off. When the output power on-off switch (228) is flipped to an upward position, power is drawn from the battery (702, 718) to the power on-off switch (228) via the first battery cable (708), which then transfers power to the two output ports (230, 232).

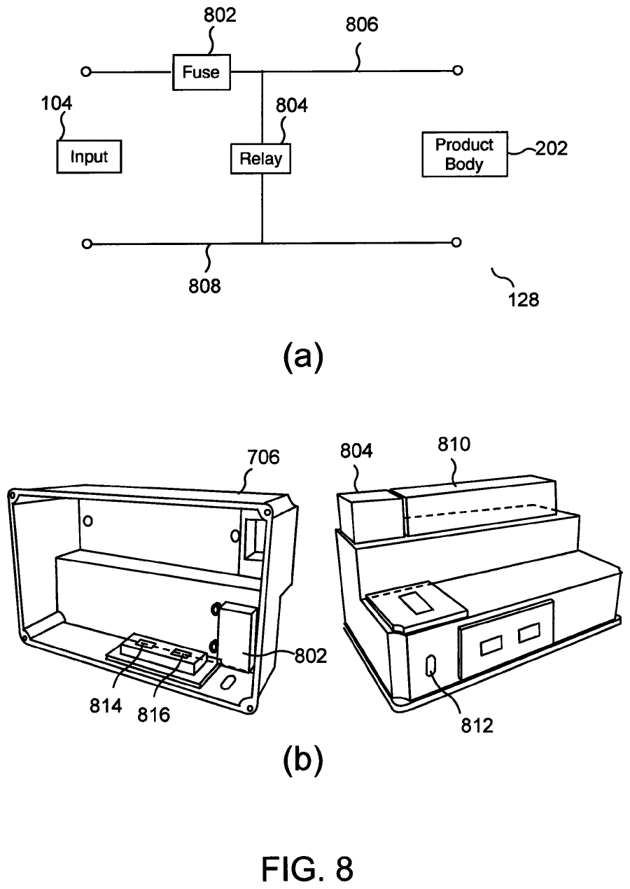

FIG. 8 illustrates a circuit diagram outlining the surge protection from the main module's shared 940 protection module and perspective views of the control panel's rear control panel cover with surge protection in the preferred embodiment of the system as a portable and expandable booster pump apparatus. Sub-figure (a) illustrates a circuit diagram outlining the surge protection from the product body's (202) shared protection module (128). The product body (202) receives power via the input block (104). For the description of this sub-figure, ‘input block (104)’ can be simply referred to as ‘input’. The shared 945 protection module (128) comprises an AC line (806) and a fuse (802) that is set between the product body (202) and the input (104) on the AC line (806). A neutral wire (808) is set up at the bottom in line with the AC line (806). A relay (804) is set up next to the fuse (802) in parallel between the AC line (806) and the neutral wire (808).

The fuse (802) protects the shared protection module (128) and the product body (202) from voltage spikes and from a sustained over current condition (e.g., short circuit) on the AC power line (806). The fuse typically does this by disconnecting and isolating the main module (802) from the AC power line (806) when such a current condition forms. The relay (804) protects the shared protection module (128) and the product body (202) by diverting any electrical disturbances from the product body (202) and absorbing the energy from said electrical disturbances. Because of these components, expanded protection for any outputs, loads, and electrical devices can be achieved.

Sub-figure (b) illustrates perspective views of the control panel's rear control panel cover (706) with surge protection. A perspective front view of the rear control panel cover (706) is shown on the left and a perspective rear bottom view is shown on the right. The rear control panel cover (706) comprises a hollow rectangular object. The rear section of the cover (706) has a top section longer than the bottom. From the rear bottom perspective view (rear control panel cover (706) drawing on the right), this longer top section appears taller at the rear of that view than the bottom section at the front of that view. A fuse (802) is installed at the bottom section on one side of the rear control panel cover (706). From the front, the fuse (802) is on the right side and from the rear bottom view, it is on the left front. The fuse (802) is flushed with the rear surface of the rear control panel cover's (706) bottom section; the fuse (802) is shown 965 protruding from the interior surface of the rear control panel cover (706) when looking at the perspective front view. From the front, the fuse (802) is directly above the auxiliary wire slot (812). A battery connector slot (814) and a pump motor connector slot (816) are shown next to the auxiliary wire slot (812) and the fuse (802); looking at the front, the aforementioned slots (814, 816) are located left of the auxiliary wire slot (812) and fuse (802).

A relay (804) is situated on the longer top section of the rear control panel cover (706), which is in line with the fuse (802) on the right side (looking from the front) of the rear control panel cover (706). The relay (804) is flush against the rear control panel cover's (706) interior surface and protrudes from the rear control panel cover's (706) rear surface. An elongated rectangular AC/DC converter (810) is situated right next to the relay (804) on the rear side of the rear control panel cover (706).

Although not a key part of the surge protection for the main module (802), the AC/DC converter (810) also plays a role in preventing voltage spikes and ensuring consistent operation of the product body (202). The AC/DC converter (810) can be used to ensure that the voltage level is kept at a constant level, particularly when a user switches between AC and DC power. Without it, the conversion between AC and DC power would not be possible, which then limits the input and functionality of the product body (202) as a whole.

The relay (804) is a 5-pin automotive relay (804) in the preferred embodiment, which has five pins, hereinafter called relay terminals. The relay terminals have connections to other components of the product body (202), which will be further shown and explained in FIGS. 9 and 10.

The fuse (802), relay (804), and the AC/DC converter (810) are replaceable components that can be changed when the main module (802) is opened up. Replacing any of these components (802, 804, 810) can be done to modify the electrical capacity of the product body (202), usually to accommodate the pump module's capacity. So, if a pump module requires an increased voltage to operate, upgrading the fuse (802), relay (804), or AC/DC converter (810) to something more powerful will help accommodate this increased voltage requirement. As a result, there is an expanded (surge) protection for the output, which can be used to increase the flexibility in booster pump usage.

The number and placement of fuses (802), relays (804), and AC/DC converters (810) are not limited to one of each as shown in sub-figure (b). These components (802, 804, 810) in other alternative embodiments can be present in any quantity, and they can be placed anywhere on the rear control panel cover (706). In one exemplary alternative embodiment, there can be two fuses (802) placed side-by-side on the top section of the rear control panel cover (706). In another alternative embodiment, the AC/DC converter (810) is removed entirely.

It should be noted that the pump motor connector slot (816), the battery connector slot (814), and the auxiliary wire slot (812) are mainly a visual reference to demonstrate the fuse (802) and relay's (804) placement on the rear control panel cover (706). The pump motor connector slot (816), the battery connector slot (814), and the auxiliary wire slot (812) are meant for allowing battery cables and other cables (i.e., from the previous figure) to connect to the product body's (202) internal components.

FIG. 9 illustrates an electric circuit schematic outlining the positive wiring relationship within a preferred embodiment device as a portable and expandable booster pump device. Most components in the figure have positive terminals (902) that are connected with wired connections (904). Components with no positive terminals (902) in this figure may also connect to components with positive terminals (902). Hereinafter, it is typically understood that any wired connection (904) will be from one positive terminal (902) of one component to another positive terminal (902) unless noted otherwise; only positive wired connections (904) will be referred to in this figure.

The AC/DC switch (304) has multiple wired connections (904) individually connecting to multiple components, based on the switch's (304) use during operation: the AC option at the top position of the AC/DC switch (304) is connected to the AC input (106); the middle position of the AC/DC switch (304) is connected to the fuse (802); the DC option at the bottom position of the AC/DC switch (304) is connected to the middle position of the battery/car switch (306).

The battery/car switch (306) has multiple wired connections (904) individually connecting to multiple components, based on the switch's (306) use during operation: the battery option at the top position of the battery/car switch (306) is connected to the battery monitor (220); the middle position of the battery/car switch (306) is connected to the DC option at the bottom of the AC/DC switch (304); the car option at the bottom of the battery/car switch (306) is connected to the car input (108).

The manual/remote switch (308) has multiple wired connections (904) individually connecting to multiple components, based on the switch's (308) use during operation: the manual option at the top position of the manual/remote switch (308) is connected to relay terminal 86 (918) of the relay (804); the middle position of the manual/remote switch (308) is connected to the fuse (802); the remote option at the bottom position of the manual/remote switch (308) is connected to the common terminal (912) of the remote control receiver (916). The positive terminal (902) on the remote control receiver (916) is also connected to this same common terminal (912). No connection to the normally closed (NC) terminal (910) is made with any of the components.

The speed controller (216) has two components with their own positive terminals (902): a speed controller power (906) and a speed controller motor (908). So, the speed controller power (906) is connected to relay terminal 87 (920) of the relay (804). The speed controller motor (908) is connected to the pump module's motor (542).

The relay (804) has five relay terminals with connections to various components. Apart from the aforementioned wired connections (904) to relay terminals 86 and 87 (918, 920), there are additional wired connections (904) from the relay (804) to the other components. Relay terminal 85 (926) acts as a ground terminal and is not connected to any components. Relay terminal 86 (918) is also connected to the normally open (NO) terminal (914) of the remote control receiver (916). Relay terminal 30 (922) is connected to the fuse (802). Relay terminal 87A (924) is connected to the output power on-off switch (228). The USB port (406) has two wired connections (904): one to the output power on-off switch (228) and another to the cigarette port (408).

The relay (804) in the preferred embodiment is an automotive 5-pin relay with five relay terminals (918, 920, 922, 924, 926). In addition to the relay's (804) role in surge protection, each relay terminal (918, 920, 922, 924, 926) is connected to various components to distribute power throughout the main module accordingly: relay terminal 30 (922) supplies power from the input either through the battery (702), the AC input (106), or the car input (108) depending on the configuration switches' (304, 306, 308) positioning; relay terminal 85 (926) acts as an electrical ground; relay terminals 87 and 87A (920, 924) get power from relay terminal 30 (922) to supply amperage to their respective components for the pump and charging output functions respectively; relay terminal 86 (918) gets power from relay terminal 30 (922) to influence the control unit power based on the what position is activated for the manual/remote switch (308). In an alternative embodiment, however, a 4-pin relay (804) can be used instead. In another embodiment, the relay terminals (918, 920, 924, 926) may be rearranged on the 5-pin relay (804). In other exemplary embodiments, a completely different type of relay (804) may be used, such as a potted relay, flasher relay, etc. Modifying the wired connections (904) to each relay terminal (918, 920, 924, 926) would be required for this accommodation.

The NC, NO, and common terminals (910, 912, 914) act as additional electrical contacts on the remote control receiver (916), which indicate that the receiver (916) has some similarities with the relay (804) in terms of power distribution. The NC and NO terminals (910, 914) act as a switch for activating control over the main module via a remote control. The common terminal (912) acts as a connection to the battery (702), the AC input (106), or the car input (108) for supplying input voltage to the remote control receiver (916). In this case, it occurs as a result of activating the remote option on the manual/remote switch (308). Power is then supplied to the remote control receiver (916) via a wired connection (904) from the common terminal (912) to the NO terminal (914). In other embodiments, the NC, NO, and common terminals (910, 912, 914) may not be present on the remote control receiver (916), or they may be present on other components like the speed controller (216) or the battery monitor (220).

FIG. 10 illustrates an electric circuit schematic outlining the negative wiring relationship within a preferred embodiment device as a portable and expandable booster pump device. Most components in the figure have negative terminals (1002) that are connected with wired connections (904). Components with no negative terminals (1002) in this diagram may also connect to components with negative terminals (1002). Hereinafter, it is typically understood that any wired connection (904) will be from one negative terminal (1002) of one component to another negative terminal (1002) unless noted, otherwise; only negative wired connections (904) will be referred to in this figure.

The battery (702) is connected to the output power on-off switch (228). The output power on-off switch (228) is connected to the USB port (406). The USB port (406) has two wired connections (904): one to the output power on-off switch (228) and another to the cigarette port (408). The car input (108) has two wired connections (904): one to the manual/remote switch (308) and another to the AC input (106). The AC input (106) is also connected to the speed controller power (906).

The battery/car switch (306) has two wired connections (904): one to the AC/DC switch (304) and another to the manual/remote switch (308). The battery monitor (220) is also connected to the manual/remote switch (308). Terminal 85 (926) of the relay (804) has two wired connections (904): one to the speed controller power (906) and another to the negative terminal (1002) of the remote control receiver (916). The speed controller motor (908) is connected to the pump motor (542).

1. An expandable multiple-module device, comprising:
a main module that has an internal control function and an internal energy storage device;
wherein the internal control function controls the main module and the internal energy storage device;
a first expandable module that connects to a first plurality of external energy input sources and the main module;
wherein the internal control function controls the first expandable module and the external energy input sources;
a second expandable module that connects to a second plurality of external electrical devices and the main module;
wherein the internal control function controls the second expandable module and external electrical devices;
a third expandable module that connects to a third plurality of external energy storage devices and the main module;
wherein the internal control function controls the third expandable module and the external energy storage devices;
wherein at least one of the external energy input sources can charge the internal energy storage device;
wherein at least one of the internal and external energy storage devices and at least one of the external energy input sources can provide energy to at least one of the external electrical devices;
wherein the first, second, and third expandable modules can be mounted and unmounted from the main module.

2. The device of claim 1, wherein the main module further comprises a protection module to provide protection for both the energy storage devices and the external electrical devices.

3. The device of claim 1, wherein the internal control function can select which external energy input source to use from the first plurality; wherein the control function can select which external electrical device to use from the second plurality; wherein the control function can select which external energy storage device to use from the third plurality.

4. The device of claim 2, wherein the protection module is a surge protection circuitry.

5. The device of claim 1, wherein at least one of the internal and external energy storage devices is a rechargeable battery.

6. The device of claim 1, wherein at least one of the external energy input sources is an AC input, a car cigarette power input, an external battery charger input, a solar panel power input, a format of nuclear energy, a format of hydropower, and a format of thermal energy.

7. The device of claim 1, wherein at least one of the external electrical devices is a water pump, a high-pressure pump, a high-volume pump, a submersible pump, a trash pump, another booster pump device, an interchangeable sliding pump module, a charging output device, or another energy output device.

8. The device of claim 1, wherein at least one of the internal control functions is a main display, a battery monitor display, a power switch, a pump speed controller, a configuration switch, or a remote-control unit.

9. The device of claim 1, further comprising an external control module that connects to a fourth plurality of external controlling devices and the main module; wherein the external control module can do what the internal control functions can do remotely through a plurality of communicational channels.

10. The device of claim 9, wherein at least one of the external controlling devices is a PC, smart mobile device, keyboard, control stick, switch, or a wired or wireless remote controller; wherein at least one of the communicational channels is Wi-Fi, a cellular connection, a wired connection, a wireless connection, a cable, Bluetooth, radio connection, or an internet connection.

11. The device of claim 7, wherein the main module has a sliding dock with a hollowed groove for the interchangeable sliding pump module to be inserted into and activated with power; wherein the interchangeable sliding pump module comprises at least a pump device.

12. A method for expanding an additional module, comprising:
providing a main module that has an internal control function and an internal energy storage device;
wherein the internal control function controls the main module and the internal energy storage device;
providing a first expandable module that connects to a first plurality of external energy input sources and the main module;
wherein the internal control function controls the first expandable module and the external energy input sources;
providing a second expandable module that connects to a second plurality of external electrical devices and the main module;
wherein the internal control function controls the second expandable module and external electrical devices;
providing a third expandable module that connects to a third plurality of external energy storage devices and the main module;
wherein the internal control function controls the third expandable module and the external energy storage devices;
wherein at least one of the external energy input sources can charge the internal energy storage device;
wherein at least one of the internal and external energy storage devices and at least one of the external energy input sources can provide energy to at least one of the external electrical devices;
providing a mechanism to mount and unmount the first, second, and third expandable modules to the main module.

13. The method of claim 12, further comprising: a protection module on the main module to provide protection for both the energy storage devices and the external electrical devices; an external control module that connects to a fourth plurality of external controlling devices and the main module; wherein the external control module can do what the internal control functions can do remotely through a plurality of communicational channels.

14. The method of claim 12, wherein the internal control function can select which external energy input source to use from the first plurality; wherein the control function can select which external electrical device to use from the second plurality; wherein the control function can select which external energy storage device to use from the third plurality; wherein the protection module is a surge protection circuitry; wherein at least one of the internal and external energy storage devices is a rechargeable battery; wherein at least one of the external energy input sources is an AC input, a car cigarette power input, an external battery charger input, a solar panel power input, a format of nuclear energy, a format of hydropower, and a format of thermal energy; wherein at least one of the external electrical devices is a water pump, a high-pressure pump, a high-volume pump, a submersible pump, a trash pump, another booster pump device, an interchangeable sliding pump module, a charging output device, or another energy output device; wherein at least one of the internal control functions is a main display, a battery monitor display, a power switch, a pump speed controller, a configuration switch, or a remote-control unit.

15. The method of claim 13, wherein at least one of the external controlling devices is a PC, smart mobile device, keyboard, control stick, switch, or a wired or wireless remote controller; wherein at least one of the communicational channels is Wi-Fi, a cellular connection, a wired connection, a wireless connection, a cable, Bluetooth, radio connection, or an internet connection; wherein the main module has a sliding dock with a hollowed groove for the interchangeable sliding pump module to be inserted into and activated with power; wherein the interchangeable sliding pump module comprises at least a pump device.
